(19) United States
(12) Patent Application Publication
(10) Pub. No.: US 2026/0338348 A1
(43) Pub. Date: Oct. 29, 2026

(54) VEHICLE EXTERIOR COMPONENT

(71) Applicant: TOYODA GOSEI CO., LTD., Kiyosu-shi (JP)

(72) Inventors: Hiroko SHIBAKAWA, Aichi (JP); Koji OKUMURA, Aichi (JP); Masaki SENDA, Aichi (JP); Takayasu IDO, Aichi (JP); Kazuki TAKAO, Aichi (JP); Masaki OKADA, Aichi (JP); Naoki TAKEDA, Aichi (JP); Yasuhisa KUMAMOTO, Aichi (JP)

(21) Appl. No.: 19/654,762

(22) Filed: Apr. 22, 2026

(30) Foreign Application Priority Data
Apr. 25, 2025 (JP) 2025-073679

(51) Int. Cl. F21S 43/20; B60R 13/00; F21S 10/02; F21V 9/40; F21W 104/00

(52) U.S. Cl. CPC F21S 43/255; B60R 13/005; F21S 10/02; F21V 9/40; F21W 2104/00

(57) ABSTRACT

A vehicle exterior component includes: a panel portion; and an illumination unit on a back side of the panel portion, the panel portion includes a transparent or translucent base material configured to transmit light emitted from a light source of the illumination unit, a design layer including a colored layer visible from an outside of a vehicle, and an interference pigment layer between the base material and the design layer, the interference pigment layer containing a lustrous pigment that reflects, as an interference color, a color of a similar hue with a color of the colored layer, and the panel portion is formed with a light-transmitting region in which a prescribed pattern is illuminated by the light emitted from the light source, and the light-transmitting region is formed by an aggregate of plural light-transmitting holes each penetrating the design layer and having a bottom surface reaching the interference pigment layer.

### CROSS-REFERENCE TO RELATED APPLICATION

This application is based on and claims priority under 35 USC 119 from Japanese Patent Application No. 2025-073679 filed on Apr. 25, 2025.

### TECHNICAL FIELD

The present invention relates to a vehicle exterior component that causes a prescribed pattern to appear on a design surface by light emitted from a light source.

### BACKGROUND ART

A technique is conventionally known in which, in a vehicle exterior component such as an emblem, a design surface is constituted by a panel member in which a colored layer is laminated on a transparent base material, the colored layer is provided with a large number of fine light-transmitting holes, and a prescribed pattern appears by light emitted to an outside of a vehicle through the light-transmitting holes when a light source is turned on (for example, refer to Patent Literature 1 below).

However, the light-transmitting holes that are originally desired to be hidden may be conspicuous except when the light source is turned on (that is, when the light source is turned off), and a design property when the light source is turned off may deteriorate. In particular, the light-transmitting holes have high visibility when diameters thereof are large. For this reason, there is a demand for a vehicle exterior component that blends in with surroundings and has inconspicuous light-transmitting holes except when a light source is turned on.

### Patent Literature 1: JP2005-88652A

### SUMMARY

The present invention is made to solve such a problem, and an object of the present invention is to provide a vehicle exterior component that can illuminate a prescribed pattern with light emitted from a light source and make presence of light-transmitting holes inconspicuous when the light source is turned off.

A vehicle exterior component according to the present invention is a vehicle exterior component including:
a panel portion; and
an illumination unit disposed on a back side of the panel portion,
wherein the panel portion includes
a transparent or translucent base material configured to transmit light emitted from a light source of the illumination unit,
a design layer including a colored layer visible from an outside of a vehicle, and
an interference pigment layer formed between the base material and the design layer, the interference pigment layer containing a lustrous pigment that reflects a color of a similar hue with a color of the colored layer as an interference color, and
wherein the panel portion is formed with a light-transmitting region in which a prescribed pattern is illuminated by the light emitted from the light source, and the light-transmitting region is formed by an aggregate of a plurality of light-transmitting holes that each penetrate the design layer and have a bottom surface reaching the interference pigment layer.

According to the vehicle exterior component configured as described above, light emitted from the light source transmits through the base material, the interference pigment layer, and the light-transmitting hole, and a prescribed pattern in the light-transmitting region can be illuminated. Further, when the light source is turned off, the light-transmitting hole appears to have a color of a similar hue with that of the colored layer around the light-transmitting hole due to operation of the lustrous pigment, and thus presence of the light-transmitting hole can be made inconspicuous as compared with a vehicle exterior component including no interference pigment layer in the conventional art.

Here, the design layer may include a black concealing layer configured to block the light emitted from the light source, and the colored layer formed on a front side of the black concealing layer.

The vehicle exterior component according to the present invention may further include an adjustment unit configured to adjust a color of light emitted from the light-transmitting region to the outside of the vehicle using a color complementary to the interference color.

In this way, when the color of the light emitted from the light-transmitting region to the outside of the vehicle changes due to an interference operation of the lustrous pigment, the color of the light can be returned to an original target color.

### BRIEF DESCRIPTION OF DRAWINGS

FIG. 1 is a perspective view of a vehicle including a vehicle exterior component according to an embodiment of the present invention;

FIG. 2 is a perspective view showing a back side of the vehicle exterior component in FIG. 1;

FIG. 3 is a cross-sectional view taken along a line III-III in FIG. 1;

FIGS. 4A and 4B schematically show a polarized pearl pigment;

FIGS. 5A and 5B show operations and effects of the same embodiment;

FIG. 6 is a schematic view of a method for evaluating a color difference at a panel portion;

FIG. 7 shows results of evaluation in FIG. 6; and

FIG. 8 shows a modification in which a complementary color layer is added.

### DESCRIPTION OF EMBODIMENTS

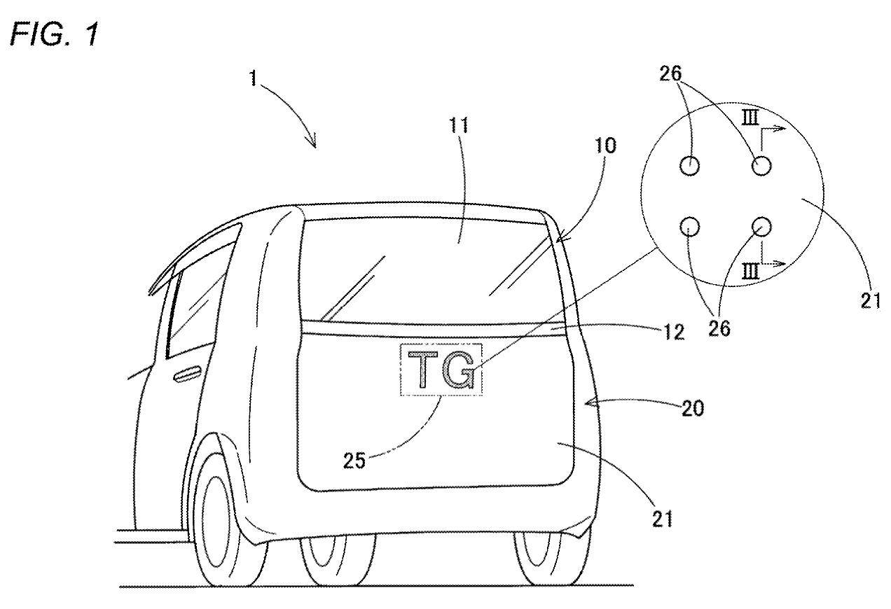

Hereinafter, an embodiment of the present invention will be described with reference to the drawings. FIG. 1 is a perspective view of a vehicle including a vehicle exterior component according to an embodiment of the present invention. As shown in FIG. 1, a back door 10 of a vehicle 1 includes a window portion 11 and a door body portion 12. The door body portion 12 of the back door 10 is provided with a back door garnish 20 as a vehicle exterior component.

The back door garnish 20 includes a panel portion 21 across the door body portion 12 in a vehicle left-right direction. The panel portion 21 is a member constituting a design surface, and is formed with a light-transmitting region 25 in a substantially central portion in the vehicle left-right direction. In the present embodiment, letters "T" and "G" in the light-transmitting region 25 can be illuminated, and a large number of fine light-transmitting holes 26 are formed in positions corresponding to "T" and "G" in the light-transmitting region 25, as shown in an enlarged view of a part of the figure.

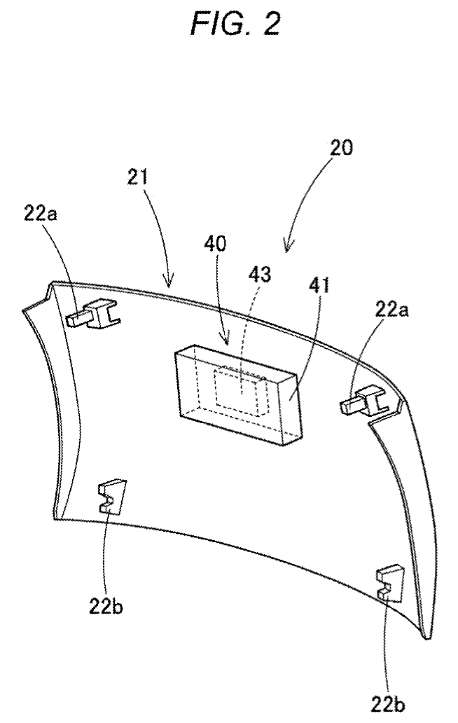

FIG. 2 is a perspective view showing a back side of the back door garnish 20. As shown in the drawing, the panel portion 21 is provided with, on a back side thereof, in addition to engagement portions 22a and 22b that engage with the door body portion 12, an illumination unit 40 at a position corresponding to the light-transmitting region 25.

The illumination unit 40 includes a housing 41 and a light source 43 provided inside the housing 41. As the light source 43, for example, a light emitting diode that generates visible light can be used.

The housing 41 is provided with an opening (not shown) that opens toward the panel portion 21, and illumination light emitted from the light source 43 can be emitted to a vehicle exterior side through the light-transmitting holes 26 provided in the light-transmitting region 25.

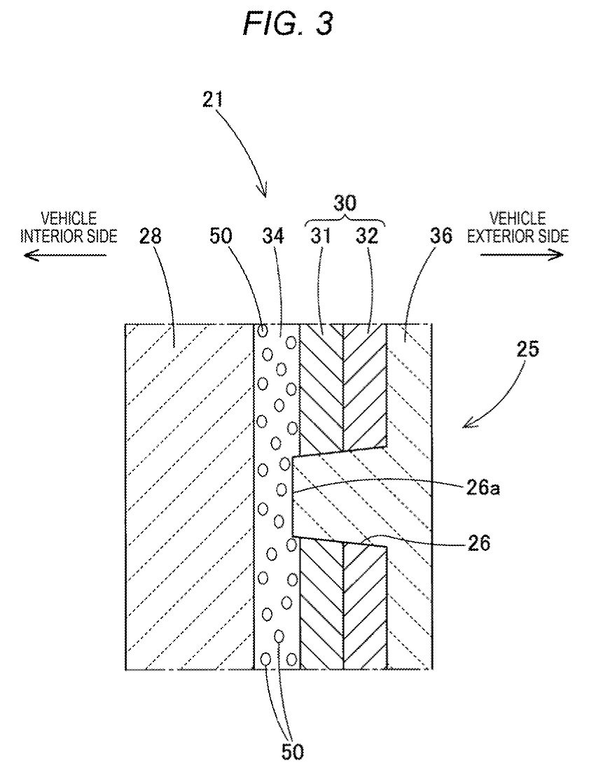

FIG. 3 shows a cross section of the panel portion 21 including the light-transmitting hole 26 provided in the light-transmitting region 25. As shown in the drawing, the panel portion 21 includes a base material 28, an interference pigment layer 34 and a design layer 30 laminated on a front side (vehicle exterior side) of the base material 28, and a hard coating layer 36 provided on a vehicle exterior side of the design layer 30. If necessary, a transparent adhesive layer (primer layer) may be added between the base material 28 and the interference pigment layer 34 or between the design layer 30 and the hard coating layer 36.

The base material 28 is made of a transparent resin that allows the illumination light emitted from the light source 43 to transmit therethrough. The base material 28 is made of, for example, polycarbonate resin or acrylic resin, and may be molded by a known injection molding method. The base material 28 may be made of a translucent resin that allows the illumination light emitted from the light source 43 to transmit therethrough.

The design layer 30 includes a black concealing layer 31 and a colored layer 32. The black concealing layer 31 is formed of a mixed material of a resin such as polycarbonate resin and carbon black, and absorbs the illumination light emitted from the light source 43 and blocks transmission of the illumination light. Here, carbon black is an example, and the black concealing layer 31 may be formed by mixing a material having a light blocking effect other than carbon black. The black concealing layer 31 has a prescribed thickness (for example, 50 μm) on a front side (vehicle exterior side) of the interference pigment layer 34 using a coating device. In FIG. 3, thicknesses of the black concealing layer 31, the colored layer 32, and the like are exaggerated.

The colored layer 32 is formed of a colored paint of a prescribed color (for example, red) and is a layer visible from an outside of the vehicle 1. For the colored layer 32, an ordinary clear paint such as acrylic resin, urethane resin, polyester resin, or epoxy resin can be used. The colored layer 32 has a prescribed thickness (for example, 50 μm) on a front side (vehicle exterior side) of the black concealing layer 31 using a coating device.

When the colored layer 32 alone has a necessary light shielding effect, the black concealing layer 31 may be omitted. The colored layer 32 is not limited to a single layer, and may be formed by laminating a plurality of layers having different colors.

The hard coating layer 36 is a transparent layer obtained by applying a known hard coating agent to a vehicle exterior side surface of the design layer 30, and mainly has a function of restricting the design layer 30 from damage. The hard coating layer 36 further has a function of restricting deterioration and degradation of the back door garnish 20 due to sunlight, wind and rain, temperature change, and the like.

Examples of the hard coating agent include an organic hard coating agent such as acrylate, oxetane, and silicone hard coating agents, an inorganic hard coating agent, and an organic-inorganic hybrid hard coating agent. In addition to the hard coating agent, a clear coating agent generally used for a vehicle exterior component may also be used.

The interference pigment layer 34 is a layer obtained by mixing a lustrous pigment into a transparent or translucent resin such as acrylic resin, epoxy resin, or vinyl resin. In the present embodiment, a polarized pearl pigment 50 is used as the lustrous pigment, and the interference pigment layer 34 has a prescribed thickness (for example, 50 μm) on the front side (specifically, between the base material 28 and the design layer 30) of the base material 28 using a coating device.

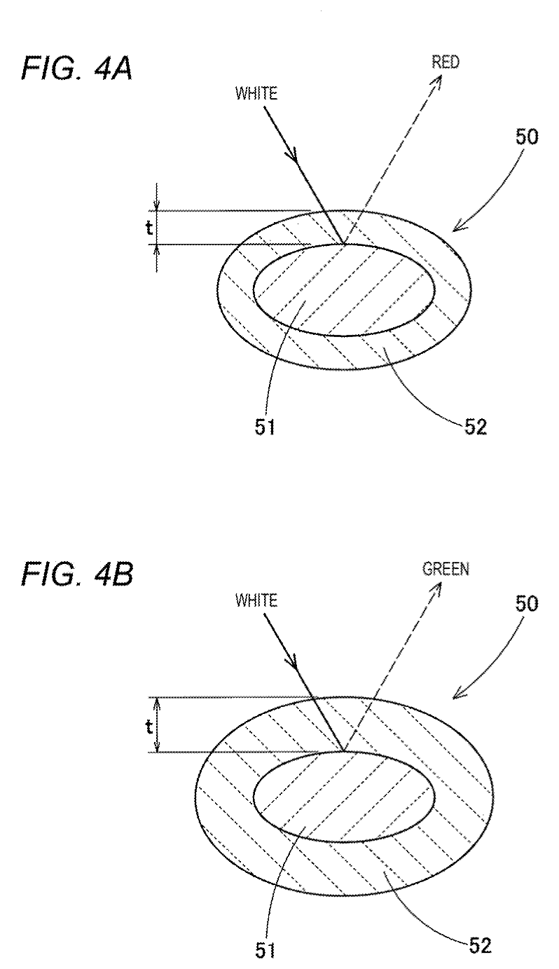

As shown in FIGS. 4A and 4B, the polarized pearl pigment 50 is obtained by forming a transparent coating layer 52 made of a high refractive index material such as titanium dioxide on a front surface of a translucent core material 51 made of fine particles such as mica or silica.

The polarized pearl pigment 50 having the above configuration allows the illumination light emitted from the light source 43 to transmit therethrough; on the other hand, when the light source is turned off, reflected light having an interference color different from a color of incident light (light from outside) can be obtained by an optical interference effect implemented by partially reflecting and transmitting the incident light at an interface between two layers having different refractive indexes. As shown in FIGS. 4A and 4B, the interference color depends on a thickness t of the coating layer 52, and the interference color can be sequentially changed to yellow, red, blue, and green by thickening the coating layer 52. In the present embodiment, the interference pigment layer 34 is formed by the polarized pearl pigment 50 which generates an interference color being a color of a similar hue with a color of the colored layer 32.

Next, the light-transmitting hole 26 will be described. As shown in FIG. 3, the light-transmitting hole 26 penetrates the design layer 30, has a bottom surface 26a reaching the interference pigment layer 34, and is opened to a right side (vehicle exterior side) in the drawing. The light-transmitting hole 26 has a prescribed size (for example, an opening diameter of approximately φ 0.1 mm) when the panel portion 21 is irradiated with laser light from a design layer 30 side in a state in which the interference pigment layer 34 and the design layer 30 are formed on the base material 28. In the present embodiment, an inside of the light-transmitting hole 26 is filled with a hard coating agent, and in certain cases, the light-transmitting hole 26 may not be filled with the hard coating agent. In the light-transmitting region 25, a prescribed pattern can be illuminated due to an aggregate of the light-transmitting holes 26.

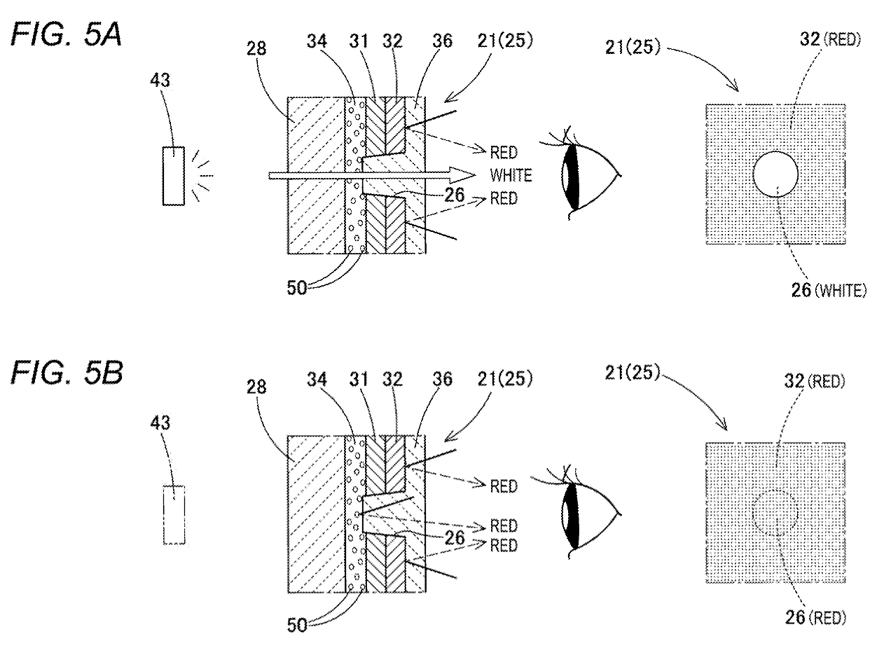

Next, operations and effects of the present embodiment will be described with reference to FIGS. 5A and 5B.

As shown in FIG. 5A, when emitted from the light source 43 (that is, when the light source 43 is turned-on), white illumination light transmits through the base material 28, the interference pigment layer 34, and the light-transmitting hole 26 and is emitted to the vehicle exterior side. For this reason, in the present embodiment, a pattern including "T" and "G" can appear by white light on a design surface of a prescribed color (for example, red) defined by the colored layer 32.

On the other hand, as shown in FIG. 5B, when no illumination light is emitted from the light source 43 (that is, when the light source 43 is turned-off), an interference color is emitted from the polarized pearl pigment 50 located at a bottom of the light-transmitting hole 26. Here, in the present embodiment, the interference color of the polarized pearl pigment 50 is a color of a similar hue with a color (for example, red) of the colored layer 32, and thus presence of the light-transmitting hole 26 can be made inconspicuous.

The effects of the present embodiment can be evaluated by measuring a color difference between an unprocessed region where no light-transmitting hole is formed and a region formed with the light-transmitting hole. The evaluation will be described below.

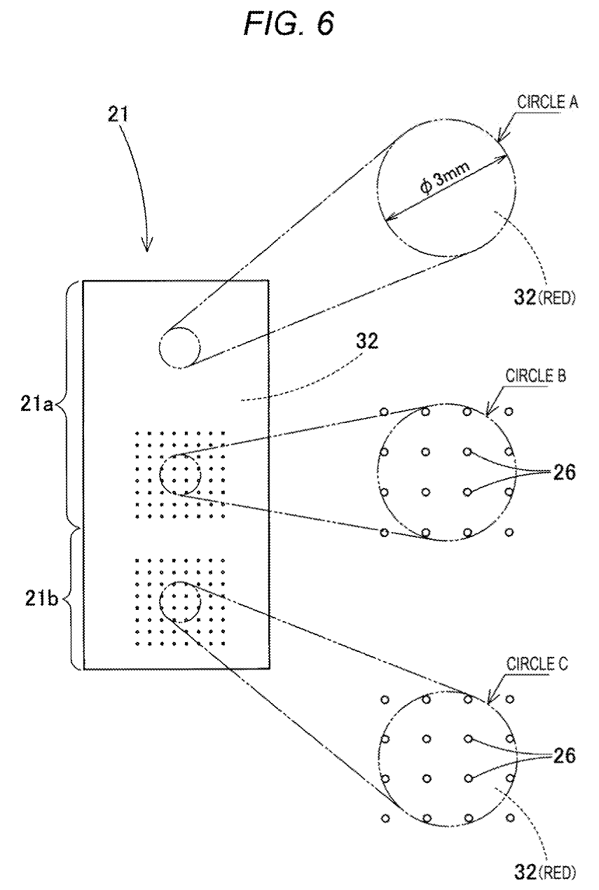

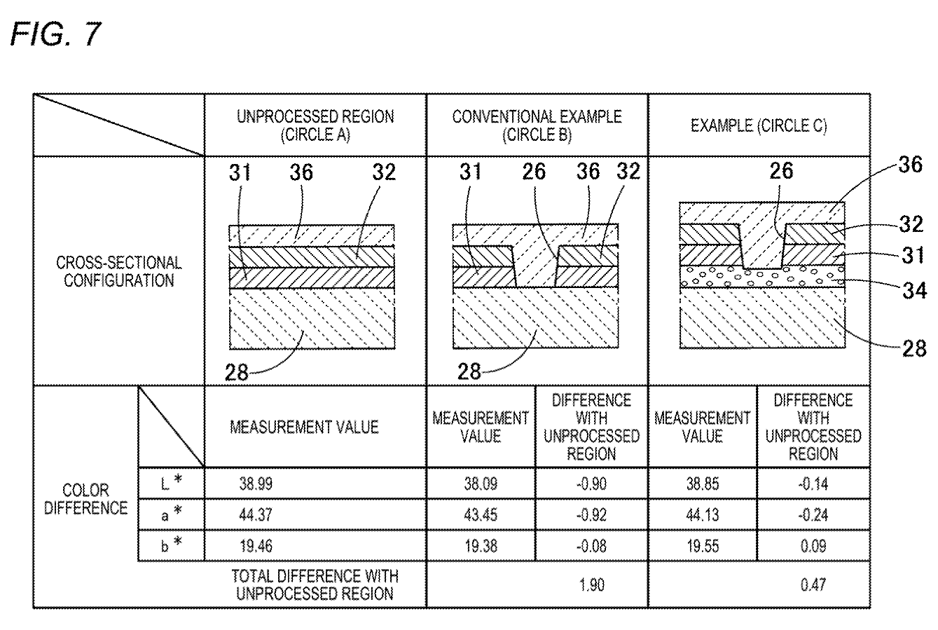

As shown in FIG. 6, in the panel portion 21 including the red colored layer 32, the light-transmitting holes 26 of φ 0.1 mm were formed in a lattice shape at a pitch of 0.9 mm in each of a region 21a on an upper side in the drawing where no interference pigment layer 34 is formed and a region 21b on a lower side in the drawing where the interference pigment layer 34 is formed. Then, numerical values L^{*}, a^{*}, b^{*} of a Lab color space in a region surrounded by each of circles A, B, and C having a diameter of 3 mm were measured by a color difference meter. As shown in cross-sectional configurations in FIG. 7, the circle A is an unprocessed region where no light-transmitting hole 26 is formed, the circle B is a region where the light-transmitting hole 26 is formed without the interference pigment layer 34 (conventional example), and the circle C is a region where the light-transmitting hole 26 is formed with the interference pigment layer 34 (example). Measurement results are shown in FIG. 7.

As shown in FIG. 7, for each of L^{*}, a^{*}, b^{*}, a difference between the conventional example, as well as the example, and the unprocessed region was obtained, and a sum of absolute values of differences of L^{*}, a^{*}, b^{*} was obtained as a color difference with the unprocessed region. When a value of the color difference is small, since the unprocessed region and the region where the light-transmitting hole is formed appear to have the same color, it can be evaluated that the light-transmitting hole is inconspicuous (high hiding effect).

According to the results shown in FIG. 7, while the color difference in the conventional example is 1.90, the color difference in the example is as small as 0.47, and it can be seen that the presence of the light-transmitting hole 26 is inconspicuous in the example having the interference pigment layer 34 as compared with that in the conventional example.

According to the back door garnish 20 in the present embodiment as described above, light emitted from the light source 43 transmits through the base material 28, the interference pigment layer 34, and the light-transmitting hole 26, and a prescribed pattern in the light-transmitting region 25 can be illuminated. Further, when the light source 43 is turned off, the light-transmitting hole 26 appears to have a color of a similar hue with that of the colored layer 32 around the light-transmitting hole 26 due to operation of the polarized pearl pigment 50, and thus the presence of the light-transmitting hole can be made inconspicuous as compared with a conventional vehicle exterior component including no interference pigment layer 34.

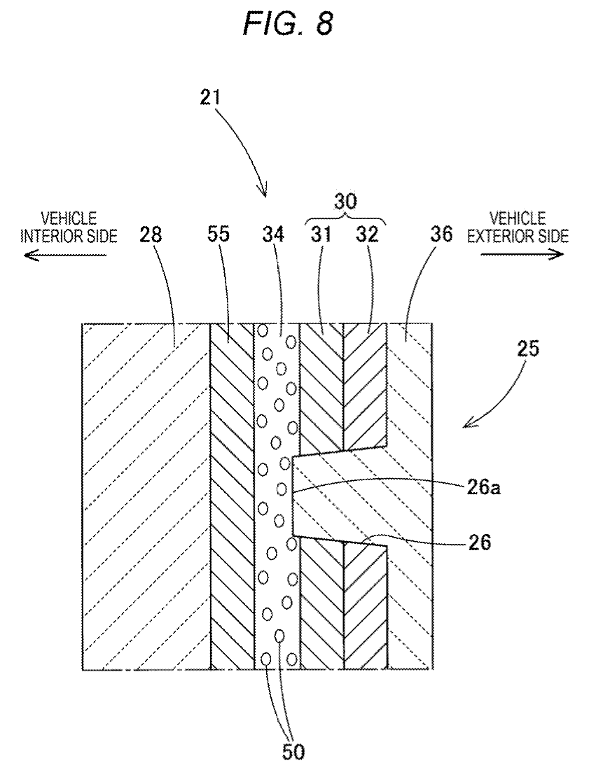

FIG. 8 shows a modification of the above embodiment. In an example of FIG. 8, a complementary color layer 55 colored in a color (for example, a greenish color) complementary to the interference color (for example, red) of the polarized pearl pigment 50 is formed on a front surface of the base material 28. The complementary color layer 55 in the example of FIG. 8 corresponds to an adjustment unit of the present invention.

In the above embodiment, when the illumination light (for example, white) emitted from the light source 43 is shifted to an interference color side in the polarized pearl pigment 50, as shown in the drawing, a color of light emitted from the light-transmitting region 25 to the outside of the vehicle can be returned to an original target color (for example, white) by forming the complementary color layer 55 colored in a color complementary to the interference color on the front surface of the base material 28 or a surface opposite to the front surface. In certain cases, instead of the complementary color layer 55, the light source 43 which shifts a color of the emitted light to a complementary color may be used.

In the embodiment described above, the interference pigment layer 34 is mixed with the polarized pearl pigment 50. Alternatively, the lustrous pigment is not limited to the polarized pearl pigment, and a lustrous pigment that can reflect a color of a similar hue with that of the colored layer 32 as an interference color can be appropriately adopted.

For example, an aluminum filler obtained by forming a colored paint as a coating layer on aluminum as a core material may be used. In such an aluminum filler, of incident light, light reflected by a front surface of the coating layer and light transmitted through the coating layer and reflected by a front surface of aluminum as the core material interfere with and strengthen each other, and thereby the aluminum filler is visually recognized as a certain color. The same effect as that of the polarized pearl pigment 50 can be obtained by making a color of the reflected light to be a color of a similar hue with that of the colored layer 32. However, since the aluminum filler has lower light transmittance than the polarized pearl pigment 50 or causes specific flickering, it is necessary to appropriately adjust a mixing amount to obtain a hiding effect.

In addition, mica having no coating layer is also included in the lustrous pigment that reflects a color of a similar hue with that of the colored layer 32 as an interference color. Since mica itself includes a plurality of layers, mica can reflect a color of a similar hue with that of the colored layer 32 as an interference color.

Although the embodiment of the present invention and the modification have been described in detail above, this is merely an example. For example, in the above embodiment, a back door garnish is described as an example of a vehicle exterior component. However, the present invention can be implemented in various modified modes without departing from the spirit of the present invention, for example, the above-described embodiment and modification can be applied to a vehicle exterior component other than the back door garnish (for example, an emblem provided at a front portion or a rear portion of a vehicle).

### REFERENCE SIGNS LIST

1 vehicle 20 back door garnish (vehicle exterior component)
21 panel portion
25 light-transmitting region
26 light-transmitting hole
28 base material
30 design layer
31 black concealing layer
32 colored layer
34 interference pigment layer
40 illumination unit
43 light source
50 polarized pearl pigment (lustrous pigment)
55 complementary color layer (adjustment unit)

What is claimed is:

1. A vehicle exterior component comprising:
a panel portion; and
an illumination unit disposed on a back side of the panel portion,
wherein the panel portion includes
a transparent or translucent base material configured to transmit light emitted from a light source of the illumination unit,
a design layer including a colored layer visible from an outside of a vehicle, and
an interference pigment layer provided between the base material and the design layer, the interference pigment layer containing a lustrous pigment that reflects, as an interference color, a color of a similar hue with a color of the colored layer, and
wherein the panel portion is formed with a light-transmitting region in which a prescribed pattern is illuminated by the light emitted from the light source, and the light-transmitting region is formed by an aggregate of a plurality of light-transmitting holes that each penetrate the design layer and have a bottom surface reaching the interference pigment layer.

2. The vehicle exterior component according to claim 1, wherein the design layer includes a black concealing layer configured to block the light emitted from the light source, and the colored layer formed on a front side of the black concealing layer.

3. The vehicle exterior component according to claim 1, further comprising: an adjustment unit configured to adjust a color of light emitted from the light-transmitting region to the outside of the vehicle using a color complementary to the interference color.

4. The vehicle exterior component according to claim 2, further comprising: an adjustment unit configured to adjust a color of light emitted from the light-transmitting region to the outside of the vehicle using a color complementary to the interference color.
